(19) United States
(12) Patent Application Publication
(10) Pub. No.: US 2005/0198957 A1
(43) Pub. Date: Sep. 15, 2005

(54) Turbocompound forced induction system for small engines

(76) Inventor: Bryan Hyun Joong Kim, Dunbar, WV (US)

Correspondence Address: Bryan Kim, 310 Grandview Pointe, Dunbar, WV, 25064, US

(21) Appl. No.: 11/079,800

(22) Filed: Mar. 14, 2005

Related U.S. Application Data
(60) Provisional application No. 60/553,057, filed on Mar. 15, 2004.

(51) Int. Cl. F02B 33/00; F02B 33/44

(52) U.S. Cl. 60/612; 60/611; 123/559.1

(57) ABSTRACT

A forced induction system that turns a conventional engine, even a small one, into an effective turbocompound engine is described. This system consists of one or more displacement device, a conventional turbocharger, and a centrifugal turbine. The displacement device would most commonly be a Roots type supercharger, and the centrifugal turbine would be connected to the crank. Turbocharger could incorporate multiple stages of compressors and turbines. The resulting combination extracts all of the available pressure from the exhaust gas, but does not suffer from a delayed throttle response that is typical of many turbocharged engines.

### CROSS-REFERENCE TO RELATED APPLICATIONS

This invention is entitled to the benefit of Provisional Patent Application APPL No. 60/553,057 filed Mar. 15, 2004.

### BACKGROUND

1. Field of Invention

This invention relates to forced induction systems for internal combustion engines, and to exhaust heat recovery systems for the same.

2. Discussion of Prior Art

It has been recognized for a long time that the typical internal combustion engine discards much useful work in its high pressure, high temperature exhaust gas. The temperature of the exhaust gas leaving the cylinder on the order of gas turbine combustor exit temperatures. This high temperature is taken advantage of in turbocharged engines to a certain extent. However, even this artifice has not been able to extract all available energy out of the exhaust gases. The amount of work needed to compress the incoming charge to a pressure appropriate for the piston engine is not enough to take complete advantage of the available pressure in the exhaust gas.

This recognition had led to the development of so called “turbocompound” engines in the 1950s. The turbochargers of these engines had oversized turbines that extracted more work than needed to drive the compressor. The excess shaft work not needed for the compressor was fed back into the crankshaft via a power coupling, often hydraulic. Although this was a promising development, the rapid adaptation of the gas turbine technology had eliminated the niche for this technology.

The practice of coupling the turbocharger to the crankshaft is also known in other applications, particularly in two stroke Diesel engines. Two stroke engines need a scavenging pump to coerce mass flow through the engine. Since turbines are notoriously ineffectual at extracting power at low volume flow rates, the crank supplied the necessary power for driving the supercharger so that it could serve as the scavenging charger at startup and low power settings. Such turbochargers are often connected to the crank by means of a clutch, and they are often allowed to “freewheel” at higher gas flow rates so as to develop a high compression without being limited by the rotational speeds of the crank.

There have been attempts to replace automotive piston engines with gas turbines. The great advantage of the turbine engine is its excellent power to weight ratio. However, for most automotive applications, this advantage is more than negated by the fact that gas turbine engines are essentially single point designs. The design point of gas turbine engines is their maximum sustained rating, and they reach their maximum efficiency at this point. Most automotive engines are sized for acceleration requirements. During cruise, they draw on the order of 25% of their rated power. Typical gas turbines are extremely inefficient at such low power ratings. Even such refinements as variable angle stators for the compressors and turbines cannot improve the engine efficiency at such low power settings to the point of being competitive with piston engines. Still, the excellent power-weight ratio of the gas turbine engine remains very attractive.

The fundamental cause for the inefficiency of the gas turbine at low power settings is the greatly reduced pressure ratio. It is well known that the fundamental parameter that governs the efficiency of any internal combustion engine is the engine's pressure ratio (or equivalently, the compression ratio). The pressure ratio of a gas turbine is very much dependent on the rotational velocity of the compressor. By contrast, a piston engine's compression ratio at maximum throttle opening is essentially independent of the engine rotational speed within much of its operating range. Therefore, the piston engine is capable of delivering even small fractions of its maximum rated power at reasonably high efficiency.

The attempt to improve the power-weight ratio of piston engines has also received much attention. The most common method of achieving this end is the addition of a forced induction system. While this method is effective, there is again an efficiency penalty. Internal combustion engines have to be operated within reasonable pressure parameters. If an external supercharger supplies a compressed charge, the piston engine's own compression ratio has to be reduced to keep the total pressure ratio within reason. However, in virtually all cases, these engines are not turbocompound engines that offer additional power extraction from the turbine shaft. Then, the engine efficiency is limited by the pressure ratio of the piston engine itself, not the total pressure ratio.

This limitation is shown drastically in racing engines. A very highly turbocharged racing engine has to operate a relatively low compression ratio, on the order of 7. By contrast, a normally aspirated racing engines usually have piston compression ratios on the order of 12. A turbocharged racing engine's overall compression ratio at maximum boost is often higher than this figure. However, the high overall pressure ratio of a turbocharged engine does not manifest in commensurately higher engine efficiency. On the contrary, turbocharged racing engines tend to exhibit low efficiencies characteristic of the reduced compression ratios of their piston engine portions. Of course, this was the rationale for the invention of the turbocompound engines of the 1950's.

Although promising, the designs of the large turbocompound aircraft engines of the 1950's are not directly suitable for scaling down for automotive use. Those engines were merely stand-alone turbocharged piston engines with a modified turbocharger system. Such a system is not the best suited system for a much smaller engine. A typical automotive engine requirement is very different from that of an aircraft engine. Automotive engines have to combine a reasonably high power-weight ratio and a healthy peak power output with a good thermodynamic efficiency at low power settings.

There is one key technology that has been known for a long time without being widely deployed-the variable compression engine. Designs for altering the compressed charge volume have been known for a long time, and a large body of such work is known in the patent literature. Furthermore, the development of such engines continue by major automotive manufacturers. For example, Ford Motor Company has assigned to it U.S. Pat. Nos. 5,136,987, 5,163,386, 6,289,857B1, 6,510,822B2, 6,568,357B1, 6,289,857B1, etc. Likewise, Audi has U.S. Pat. No. 4,602,596, Nissan has U.S. Pat. Nos. 4,286,552 and 6,561,142B2, while General Motors has U.S. Pat. Nos. 6,467,373B1 and 6,450,136B1. All of these and many other similar patents describe effective means of altering the compression ratio of the engine, and many incorporate means of altering the swept volume of a piston engine as well.

Another means of effectively varying compression is to delay the ignition or fuel injection timing such that the peak pressure is reached later in the engine's rotational cycle. While the true variable compression engines mentioned in the previous paragraph are fundamentally more flexible than ignition timing variation, ignition timing variation is very easy to effect and have been in commercial use for years. In many cases, variable ignition or injection timing will confer most of the advantages of a variable compression engine without any drastic changes.

In light of the availability of such designs, it is possible to conceive of a novel forced induction system that turns these internal combustion engines into turbocompound engines that offer a substantially greater power/weight ratio and efficiency, one that can be applied to smaller, passenger automobile sized engines, without the limitations of the turbocompound engines used in the 1950s.

### SUMMARY

This invention entails a novel forced induction system that is capable of being fitted to any conventional or variable compression internal combustion engine. This forced induction system will turn any conventional internal combustion engine into a turbocompound engine that exhibits a very high power-weight ratio. The high efficiency of piston engines at low power settings is retained. Its efficiency is further enhanced at high power settings, exceeding that of the conventional piston engine alone. This engine operates a cycle that continuously varies from a piston engine cycle (Otto or Diesel) at the minimum engine speed to an augmented cycle offering the complete expansion of the combustion products.

These desirable features are achieved through a novel combination of the following prior art features: at least one turbocharger with at least one turbocompressor stage, at least one crank driven displacement device (which can be of the Roots type, although that specific configuration is not necessary), optional intercoolers, and an optional turbine coupled to the internal combustion engine crank.

### OBJECTS AND ADVANTAGES

The objects and advantages of this invention are:
(a) to provide an exhaust heat recovery system for low compression ratio internal combustion engines;
(b) to provide a turbine based exhaust heat recovery system for engines whose exhaust gas flow rate is too small for use with prior art geared turbines;
(c) to provide a turbine based exhaust heat recovery system that is subjected to much lower thermo-mechanical stresses than prior art exhaust heat recovery schemes;
(d) to provide a multi-stage forced induction system to achieves very high pressures at high polytropic efficiencies;
(e) to provide a forced induction system ideally suited for operating characteristics of variable compression ratio engines;
(f) to provide an internal combustion engine system that offers very high power to weight ratio of low compression ratio turbocharged engines while retaining the high efficiency of high compression ratio engines;
(g) to provide a turbocharger based high pressure forced induction system that does not suffer from the turbo-lag of prior art high pressure turbocharger systems; and
(h) to provide an engine system with very large power turndown ratio that retains excellent efficiency throughout its entire operating range.

Other objects and advantages will become apparent from a consideration of the ensuing description and drawings.

### DRAWINGS

FIG. 1 is a schematic layout of this invention as expected for fixed compression ratio engine applications.

FIG. 2 is a higher pressure supercharging scheme envisioned for variable compression engine systems, or for low fixed compression ratio engines.

FIG. 3 is a very high pressure supercharging scheme envisioned for use with high powered systems such as race cars and aircraft.

FIG. 4 is a high pressure supercharging scheme suitable for use with complete expansion piston engines, very small engines, and aircraft engines.

FIG. 5 is a large volume flow system suitable for engines that sustain a large power output.

### DESCRIPTION

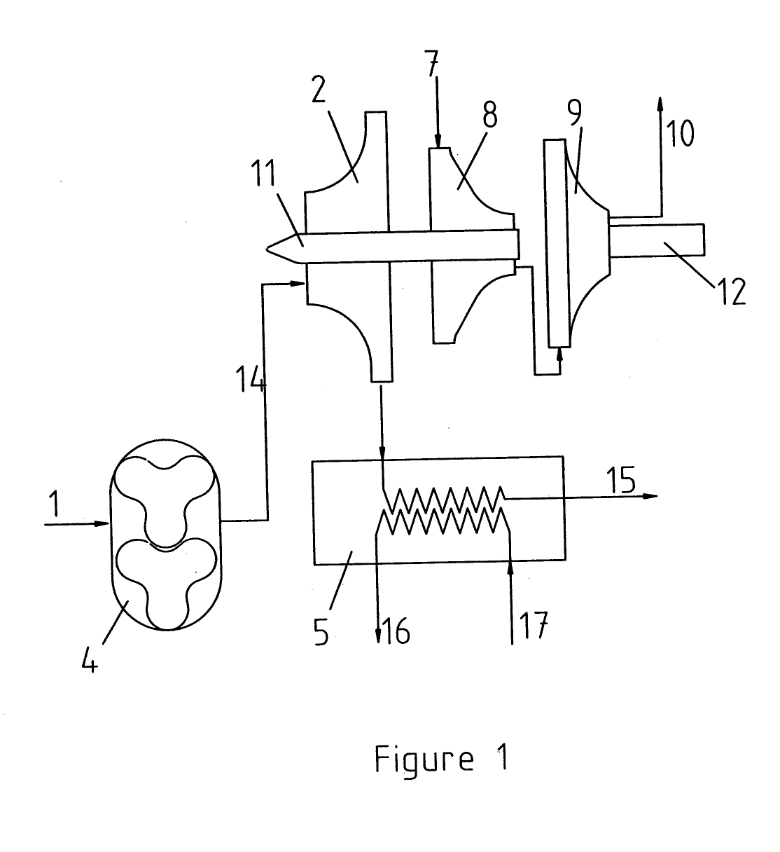

FIG. 1 shows the schematic of an optimal embodiment for fixed compression ratio engines. Note the piston or rotary engine to which this invention will be attached is not shown in this schematic; it is a prior art item not directly related to this invention. (Throughout this document, the phrase “piston engine” is meant to denote an internal combustion engine of a type in which the thermal energy of the combustion products is converted to non-thermal energy by means of a displacing member in the combustion chamber that increases the volume of the combustion products. This phrase is used since the vast majority of engines of this type do indeed use pistons as the displacing member of the combustion chamber. However, other mechanisms such as rotors can be used, so the phrase “piston engines” should be construed as referring to all such engines. The phrase is meant to exclude internal combustion engines that use acceleration of the combustion products and forces exerted by the accelerating gases to extract power from the combustion products. Principally, gas turbine engines fall in this excluded category. Likewise, throughout this document, the phrase “Roots device” refers to any device that effects a compression or expansion of a gas by varying the enclosed volume of one or more chambers in which the gas is contained. Roots superchargers are among the most common of such devices, although piston compressors also fall into the category of such devices. The phrase is meant to exclude devices the use the acceleration or deceleration of gases to effect a pressure change, which are sometimes called “dynamic” compressors or expanders.)

This schematic shows a “two shaft” turbocompound arrangement. The Roots device 4 feeds the centrifugal turbocompressor 2. In this schematic, the turbocompressor feeds the intercooler 5, which discharges the compressed and cooled stream 15 into the piston engine manifold, which is not shown in this diagram. The intercooler is cooled by medium 17, which will almost invariably be water, oil, or air. The Roots device 4 is connected to the crank of the piston engine. The piston engine's exhaust stream 7 is supplied to the high pressure turbine 8. This turbine is connected the compressor 2 through the compressor drive shaft 11. The high pressure turbine discharges into the low pressure turbine 9, which is mounted on the power-extraction shaft 12, which is connected to the crank of the engine or a suitable power absorbing device. The fully expanded exhaust gas stream 10 is discharged into engine exhaust system. Very often, the shaft 12 will also be the driving shaft for the Roots device 4.

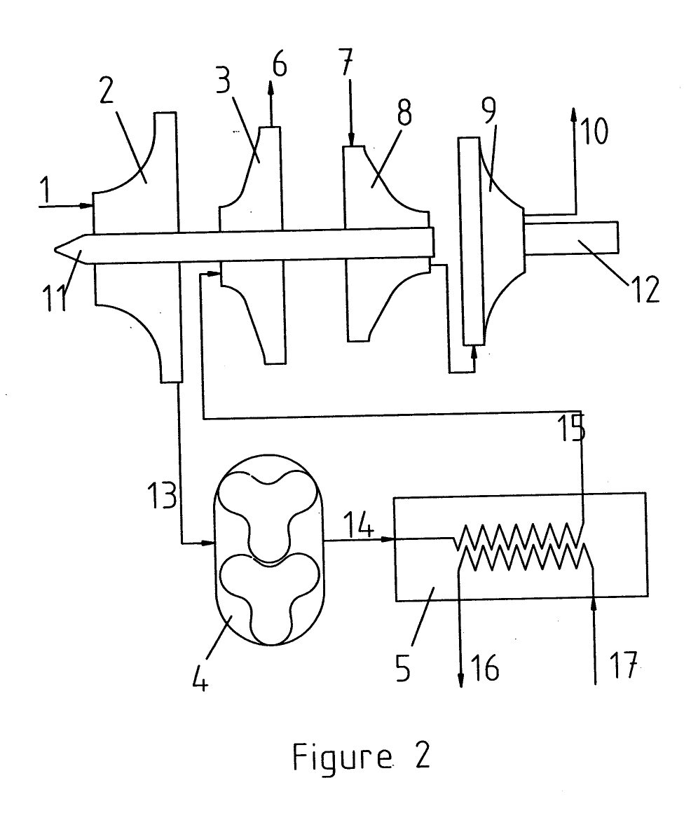

FIG. 2 shows an optional addition to FIG. 1. A higher pressure centrifugal turbocompressor 3 has been added. Roots device 4 has been placed between the two turbocompression stages. The rest of the schematic is identical to that of FIG. 1.

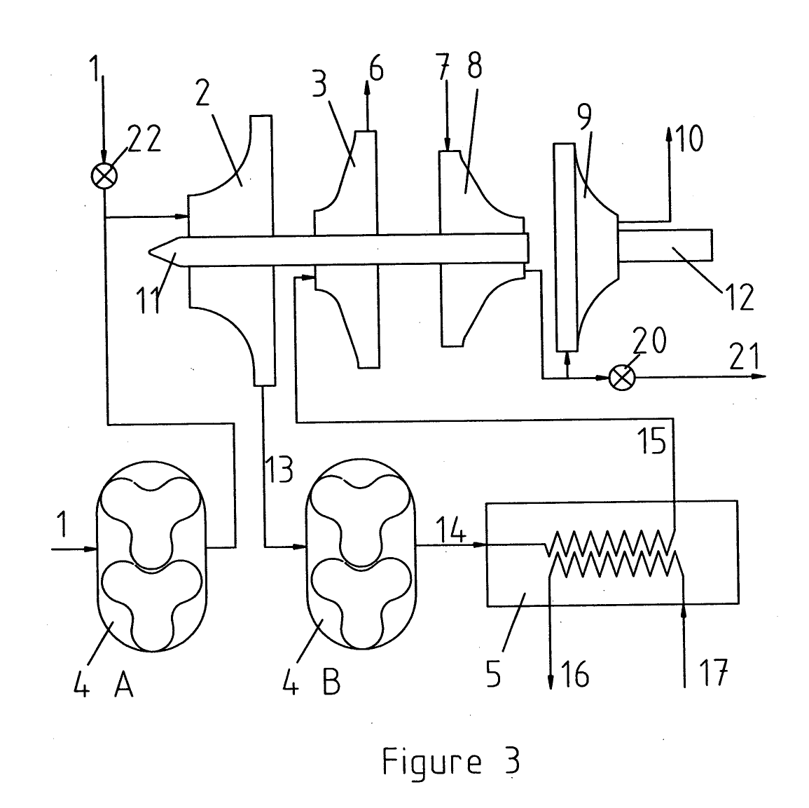

FIG. 3 shows two optional features added to the schematic of FIG. 2. One is the low pressure Roots device 4A, which is connected to the crank of the piston engine. A valve to bypass this device, 22, is also shown, although it may not be present in all applications. A valve to cause the exhaust gas to bypass the power extraction turbine is shown as 20.

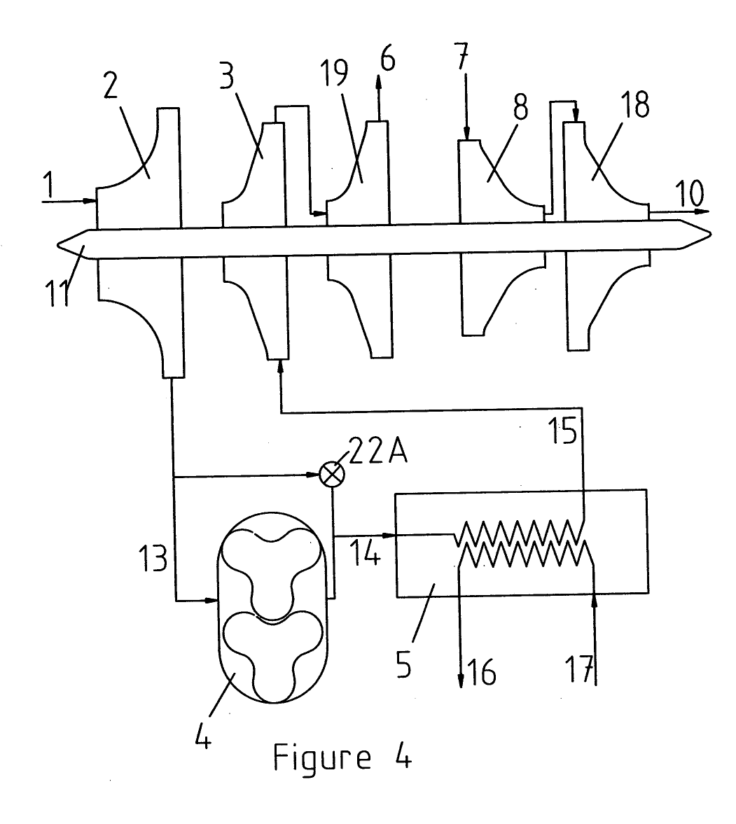

FIG. 4 is a high pressure system intended for use with complete expansion piston engines, high altitude engines or very small engines. The ambient air stream 1 feeds the low pressure turbocompressor 2. This turbocompressor discharges into the Roots device 4, which is connected to the crank and feeds the intercooler 5 in turn. Although not essential, aircraft installations will often sport a bypass valve 22A to isolate the Roots device 4 from the rest of the forced induction system. The intercooler discharge stream 15 feeds the intermediate pressure turbocompressor 3, which feeds the high pressure turbocompressor 19. The compressed charge stream exiting from turbocompressor 19 feeds the piston engine intake manifold. The high pressure exhaust gas stream 7 first drives the high pressure turbine 8. This turbine feeds the low pressure turbine 18. Both turbines are connected to the turbocharger shaft 11. The fully expanded exhaust gas stream 10 is discharged into engine's exhaust system or the atmosphere, as in previous schematics.

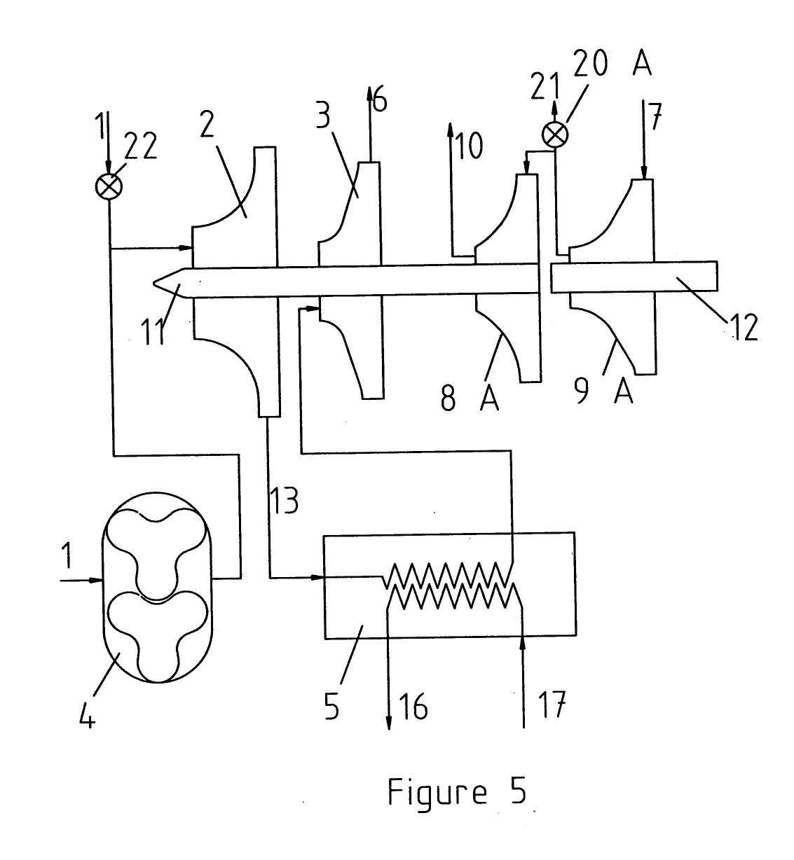

FIG. 5 is a system optimized for large engines. The compressor side arrangement is very similar to the prior figures. Ambient stream 1 feeds the Roots device 4, which is coupled to the crank of the piston engine. The Roots device 4 can be bypassed by means of valve 22. If the bypass valve is opened completely so that turbocompressor 2 is exposed to the ambient pressure, Roots device 4 would be disengaged. The low pressure turbocompressor 2 feeds the intercooler 5, which discharges into high pressure turbocompressor 3. The high pressure, high temperature exhaust stream 7 is supplied to the high pressure power extraction turbine 9A, which is coupled to the crank. The compressor driving turbine 8A is suppled by the partially expanded gas from 9A. There is shown a wastegate 20A that diverts some of the exhaust gas from 8A to the stream 21, which does not pass through any turbines.

### REFERENCE NUMBERS

1 Ambient air stream.
2 Low pressure turbocompressor.
3 Intermediate pressure turbocompressor.
4 Crank driven displacement device.
5 Intercooler.
6 Forced induction system discharge stream.
7 High temperature, high pressure exhaust gas stream.
8 Compressor driving turbine.
8A Low pressure, compressor driving turbine.
9 Power extraction turbine.
9A High pressure, power extraction turbine.
10 Fully expanded exhaust gas stream.
11 Turbocharger shaft.
12 Power extraction shaft.
13 Partially compressed air stream.
14 Displacement device discharge stream.
15 Intercooler discharge stream.
16 Intercooler cooling medium discharge stream.
17 Intercooler cooling medium intake stream.
18 Low pressure, compressor driving turbine.
19 High pressure turbocompressor.
20 Power turbine, bypass valve.
20A Turbocharger bypass valve (wastegate).
21 Exhaust to atmosphere.
22 Ambient stream Roots device bypass valve.
22A Compressed stream Roots device bypass valve.
   Operation

This invention increases the absolute pressure of the environment in which the piston engine operates, and uncouples the effective expansion ratio of the engine from its effective compression ratio. The exact magnitude of the pressure increase will depend on the exact application necessary. A low pressure application is expected to supply the piston engine intake manifold with pressures of 2 to 3 atmospheres and used with fixed compression ratio engines. An intermediate pressure application is expected to generate 4 to 7 atmospheres, and used with variable compression ratio engines. They could also be used with a low fixed compression ratio engine that are intended for nearly continuous operation at full rated power. A high pressure application is expected to generate 10+atmospheres of intake manifold pressure, and used with complete expansion engines that offer a different compression and expansion ratios within the piston engine itself. The principles of constructing effective embodiments of this invention will be explaining by first discussing the combinations and, more importantly, the component sizing/matching criteria of the different design elements. That discussion will be followed by examples revealing how common applications would be served by different embodiments. This invention is not restricted to the exact embodiments described below, as it will become obvious that virtually all internal combustion engines that operate in any environment can be fitted with a forced induction system designed according to the principles described below.

Operating Principles of the Various Design Elements

The following is the list of design elements of this invention. This section describes the principles for designing the different embodiments of this invention by using some of those embodiments as examples of various design decisions. A concise description of the envisioned embodiments will be given separately in a later section.
1. Displacement supercharger stages.
2. Turbocompressor stages.
3. Turbocharger driving turbine stages.
4. Power extraction turbine stages.
5. Intercooler stages.

The novelty of this invention lies in the sizing and location of these elements. The first item on the above list is the displacement supercharger. A displacement compressor, like a Roots compressor or certain types of piston compressors, have the ability to function as either a compressor or an expander. If the Roots device is operated at a speed that causes its outlet pressure to exceed its inlet pressure, the Roots devices absorbs shaft work and functions as a compressor. If the inlet and the outlet pressures are exactly the same, the Roots device absorbs little work (some work is always absorbed due to friction and nonidealities, of course) and does nothing to the flow. If the inlet pressure exceeds the outlet pressure, then the Roots device functions as an expander and extracts work from the enthalpy of the fluid stream. This ability of a displacement machine to function as both a compressor and expander, and transition gracefully between those two functions, is one of the keys to this invention. Even if the Roots device is not operated as an expansion device, the fact that it is not tied to any fixed compression ratio is used to advantage.

FIG. 1 is a schematic of the first embodiment of this invention. It is a low pressure gain forced induction system suitable for use with a fixed compression ratio engine. For example, FIG. 1 would be suitable for use with a common automotive compression ignition or spark ignition engine. A displacement type supercharger 4 is placed upstream of the turbocompressor 2. The upstream pressure of the ambient stream 1 is determined by the atmospheric conditions. The rotational speed of the Roots device is determined by its gearing ratio with the internal combustion engine crank. However, the pressure at the outlet of the Roots device is determined by both the rotational speed of the Roots device and the rotational speed of the turbocompressor 2.

At the lowest power setting, the piston engine is rotating at a low speed. Most of the current generation turbodiesel engines for small automobiles operate with a fixed compression ratio on the order of 20. This pressure ratio is set for easy starting of the engine. A greater power to weight ratio would be realized if the compression ratio were reduced to 14 or so, and a forced induction system used to supply higher pressures to the engine manifold. But such a relatively low compression ratio of a compression ignition engine may cause difficulties in starting a cold engine. A forced induction system like FIG. 1 would make such engines start much more easily, as the large displacement supercharger 4 can generate significant pressure gain even at very low rotational speeds.

The location of the Roots device 4 upstream of the turbocompressor 2 is very important here. Since 4 is fed directly by the ambient stream, its rotational speed determines the mass flow rate of the engine. Compare this configuration with the location of the Roots device 4 in FIG. 2, which is in between two turbocompressor stages. Since the Roots device 4 in FIG. 2 has to accommodate the compressed air discharged from the low pressure turbocompressor 2, its volume flow rate needs to be matched to a denser charge. This means that if the engines of FIGS. 1 and 2 were designed for the same maximum mass flow rates at the same piston engine maximum rotational speeds, the Roots device 4 of FIG. 2 would be smaller than that of FIG. 1. However, at low speeds, the turbomachinery does little work, leaving all of the compression duties to the Roots devices. At this point, the larger mass flow would be obtained by the larger Roots device of FIG. 1, resulting in greater power.

Of course, it is well known that Roots type devices generate mass flow rates that scale fairly linearly with the engine rotational speed, resulting in a nearly constant torque throughout the engine speed ranges; Roots superchargers reach their design pressures at relatively low engine speeds. In FIG. 2, the largest volume flow machine is the turbocompressor 2, so the engine's total volume flow, and thus the mass flow, is dependent on the rotational speed of the turbomachinery, not the crank. When the turbomachinery is not rotating quickly enough, it does not generate as much mass flow as a Roots device that is designed for identical maximum mass/volume flow rate. Since the turbomachinery is not coupled to the engine crank, the layout of FIG. 2 would exhibit a certain amount of time delay to power control commands, commonly known as a “turbo-lag.” Layout of FIG. 1 would not exhibit any turbo-lag.

At very low speeds, the Roots device 4 would be functioning as a scavenging pump if a two stroke engine is used. Of course, a two stroke engine would greatly improve the power-weight ratio of the overall system. One prior art item that arranges a turbocompressor and a displacement compressor is Yingling's U.S. Pat. No. 2,401,677. The reason for that design was to permit a turbocharger to be used in a two stroke compression ignition engine. Since a turbocharger needs a substantial volume flow rate to function, a Roots supercharger was included downstream of the turbocompressor in order to permit startup and low power operations. As mentioned already, this layout would cause a substantial turbo-lag, but Yingling's main design intent was to provide a stationary engine for power generation. For such a steady state operation at near maximum power ratings, the turbo-lag does not become an issue. However, similar ends to that desired by Yingling can be achieved simply by coupling the turbocharger to the engine crank by means of gears and a clutch, as mentioned already.

At low-intermediate engine speeds, the displacement supercharger 4 will be generating a very healthy compression, near its maximum design value. For the engine of FIG. 4, this would mean that nearly maximum torque would be available at low-intermediate engine speeds. This is precisely the advantage of a displacement supercharger, that the engine's maximum torque is available at low speeds. The intercooler 5 will reduce the temperature of the compressed charge. The volume flow rate will still be too low to make the turbomachines effective, but that will not matter much, since the engine is generating a near maximum torque already due to the displacement supercharger. For the engine of FIG. 2, with its relatively smaller supercharger, there maximum mass flow rate attainable at this low engine speed will be smaller than the engine of FIG. 1, resulting in an engine torque that is significantly less than the maximum design value, which can only be reached when the turbomachines spool up to high speeds.

One very desirable layout would be a compression ignition Wankel rotary engine. A Wankel engine is a very elegant concept with few moving parts, but the geometry restrictions limit it to a compression ratio of 12 or so. This is a perfect compression ratio for use with a 3 atmosphere forced induction system, but the conventional systems have not been able to supply adequate boost pressure at startup and low power settings. This invention is very much cable of supplying the needed boost at low rotor speeds. The combination of this invention with a Wankel engine should permit a practical compression ignition Wankel engine system to be built. Using a spark assist for ignition would make starting even easier.

Such an engine would be most elegant, with very few moving parts, and no valves. The fact that Wankel engines have a “combustor” side and the intake/exhaust side is also advantageous. For very high pressure engines, the entire engine does not need to be strengthened, as a four stroke piston engine would have to be. The additional structure needed for the higher pressure would be concentrated on the “combustion” side of the Wankel engine, so Wankel engine's weight does not need to scale linearly with the maximum pressure. The absence of valves also make it easy to attain very high pressures. Although the peak pressures would be higher, pressure ratios among the different chambers would be determined by the engine geometry itself, so overall leakage issues would substantially not alter the polytropic efficiencies of the rotor operation. Combining this invention with a Wankel rotary engine would realize the inherent potential of the Wankel engine.

The operating conditions shift as the engine speed increases. Consider FIG. 1 again. As the engine power is increased, the rotational speed of the turbomachines will increase, along with their effectiveness. As the turbocompressor 2 becomes increasingly more effective, it will ingest more and more air, and cause a pressure drop at the turbocompressor inlet. Of course, the turbocompressor inlet is also the outlet of the Roots device. As the Roots supercharger outlet pressure drops, it will absorb less shaft work from the crank. In this way, the compression duty gracefully transfers to the turbocompressor. The fact that the Roots supercharger draws less power from the engine crank translates to more net power output from the engine crank. In this way, the turbocharger adds to the power output and the efficiency of the engine. Therefore, the engine torque does increase a little bit as the mass flow rate increases. However, the magnitude of the torque change will be much less than a conventional turbo-lag, which is caused by the change of manifold pressure.

As the engine power is increased even more, the turbocompressor 2 would ingest ever greater volumes of air. It is quite possible to size the Roots device 4 and turbocompressor 2 in FIG. 1 such that the outlet pressure of the Roots device 4 would be less than its inlet pressure when turbocompressor 2 is rotating near its design angular velocity. This would cause the Roots device to function as an expander, and add power to the engine crank. Of course, the engine's mass flow is still limited by the mass flow of the Roots device, which is throttling the mass flow at this point.

This is a perfect scenario for aircraft engines. Supercharged aircraft engines of the 1940's had to resort to a throttle placed upstream of a multi-stage supercharger, whose pressure ratio was designed for high altitudes. At sea level, a throttle had to reduce the engine inlet pressure to prevent too high a manifold pressure on the piston engine. Alternatively, a turbocharger wastegate was used to dump a part of the available energy from the exhaust for the same purpose. However, the throttle does absolutely no work at all, and causes a large entropy rise in the air stream. Dumping useful work at the wastegate is not much more efficient a solution. It is much better to reduce the inlet pressure by extracting the enthalpy of the inlet air as shaft work. As the aircraft gains altitude, the bypass inlet throttle (shown in FIG. 5 as 22) can be opened to permit a larger volume flow to the turbomachines. At at appropriate altitude, the Roots device 4 should be de-clutched and stopped altogether.

The amount of work that can be extracted from the Roots device 4 is limited by the enthalpy of the ambient air in FIG. 4. The location of the Roots device 4 in FIG. 2 is now shown to advantage. The enthalpy of the stream 13 is governed by the amount of enthalpy imparted by the turbocompressor 2 as well as the enthalpy of ambient air itself. Thus, a much larger amount of power can be extracted from the Roots device of FIG. 2 than that of FIG. 1. Neither of these devices is isentropic in real life, and the location of intercooler 5 down stream of the Roots device and the low pressure turbocompressor ensures that the excess entropy is jettisoned at a relatively low temperature.

In FIG. 2, the low pressure turbocompressor 2 supplies compressed air into the higher pressure turbocompressor 3. A single stage of centrifugal compressor is unable to generate much higher pressure ratio than 3 without suffering large polytropic inefficiencies. Axial compressor stages are limited to pressure ratios on the order of 1.5. Much higher manifolds than what can be efficiently supplied by a single stage can be useful if a variable compression ratio engine is used. Thus, a second stage is shown as turbocompressor 3. It should be understood that there can be additional stages as desired, especially if axial compressors are used.

Such a multi-stage turbocharger would exhibit even more rotational inertia than the current turbochargers. As will be pointed out below, a partial extraction of the exhaust energy in a power recovery turbine 9 leave much less energy than in conventional turbochargers. With a larger rotational inertia and less turbine power, the turbocharger acceleration would be much slower than in conventional turbochargers. It would be in line with conventional gas turbines' delayed response to power setting changes, which is on the order of five to ten seconds. In fact, any scheme that used a high speed turbine for complete expansion would suffer from this delayed response. However, the use of a Roots device 4 completely alleviates this issue of the turbo-lag. Indeed, the Roots device 4 is what makes an integration of a complete expansion turbine system practical for automotive applications.

Being able to effectively use multi-stage turbochargers without suffering any turbo-lag means that much larger forced induction system pressure gain is practical. A variable compression engine is now shown to advantage. If the forced induction system realizes a volume compression ratio of 4, an appropriate compression ratio of the piston engine would be approximately 6. Such a low compression ratio does not make for efficient low speed operation or easy starting, so the compression ratio should be varied as the function of the manifold pressure. If a separate system for supplying compressed air for startup duties were integrated into the engine, a low fixed compression ratio engine would be practical.

In most variable compression piston engine designs, the compressed charge volume (the volume of the compressed charge when the piston is at the apex of the compression stroke) is varied. If the forced induction system offers sufficient pressure gain to hold the peak pressure ratio of the engine constant even when the compression ratio is reduced, the compressed charge volume is directly proportional to the engine's the total mass flow rate through the engine per stroke. Of course, the total mass flow rate per stoke determines the engine's torque.

A piston engine's total mass flow rate is governed by three factors-the cyclic speed (rotational speed), the maximum pressure attained, and compressed charge volume. The maximum pressure of the engine is limited by the mechanical stresses on the engine, and cyclic rate is limited by mechanical and ignition considerations. However, the compressed charge volume can be increased independently of those parameters, meaning that power can be increased without resorting to higher peak pressures or rotational speeds. For example, consider a cylinder/piston combination with an initial compressed charge volume of 20 cubic centimeters, and a fully expanded volume of 480 cubic centimeters. Such an engine would have a compression ratio of 24. If the piston stroke travel range is altered so that a compressed charge volume of 80 cubic centimeters and a fully expanded volume of 540 resulted, the compression ratio would be reduced to 6.75. This reduction in compression ratio is the direct result of an increase in the compressed charge volume by a factor of 4.

The forced induction system will have to supply a mass flow rate that scales with the compressed charge volume. In the above example, the forced induction system should supply approximately four times the mass flow rate per piston engine stroke to fill the enlarged compressed charge volume to the design peak pressure. Although neither turbocompressors or Roots compressors equal the polytropic efficiency of the piston, a reasonable application of intercoolers can definitely jettison undesired cycle entropy rise caused by compressor nonidealities.

A typical 2 liter automotive turbodiesel engine is designed to produce about 90 horsepowers. A variable compression ratio engine that reduces the compression by a factor of 4, coupled to a forced induction system that offers a volume compression ratio of 4, will increase the power by a factor of 4. In other words, a 2 liter turbodiesel engine can produce 360 horsepowers while operating at the same rotational speed and peak cycle pressure, aside from the additional power gained at by the complete expansion turbine. The additional turbine power extraction should push the power output to over 400 hp, while using no additional fuel and making the engine quiet. Using a 2 stroke engine would push the peak power rating to well over 500 horsepowers. Coupling such a variable compression ratio engine with a forced induction system that offer the required pressure gain without suffering any turbo-lag represents a quantum improvement in internal combustion engine designs.

It is easy enough to envision that the large volume capacity of the Roots device in FIG. 1 and the power extraction efficacy of the Roots device in FIG. 2 can be combined in one device. FIG. 3 shows such a layout. It should also be understood that additional Roots devices can be placed as desired, although in many cases it is worthwhile to keep the mechanical layout simple. It is generally more efficient to obtain a large pressure rise by using many stages of modest pressure rise compressors rather than a single stage, so it is envisioned that some application will indeed have even more stages of both Roots devices and turbocompressors. Likewise, an intercooler can be placed in the forced induction system discharge stream 6. Such an inclusion would be particularly useful for a spark ignition engine, or a very high pressure compression ignition engine.

The Roots device is not the ideal method of extracting power. A proper turbine operating on the favorable pressure gradient of the exhaust gas is a much better method. Thus, FIGS. 1, 2 and 3 all include a turbine. If such a turbine is included, the Roots devices should be designed to offer a modest pressure gain at the maximum volume flow rate of the forced induction system. With the presence of a turbine, it does not make sense to use the Roots device as a power extraction device, except in the special case of an aircraft engine when some throttling at maximum turbomachinery speed is required.

There are three issues in incorporating a turbine into a small internal combustion engine like an automobile engine. The first is the relatively small gas volume flow. It is technically difficult to make very small turbines efficient, unless they are permitted to rotate at very high speeds. A typical turbocharger rotates at 100,000 RPM. By contrast, a crank driven supercharger rotates at about 30,000 RPM. In theory, it is possible to use a larger turbine to reduce the rotational speed, but the fabrication of a relatively large turbine with extremely tight clearances that will handle low volume flow without unacceptable leakage is expensive. The second problem is the high temperature of the exhaust, which is a typical gas turbine combustor exit temperatures. This is not a serious problem in and of itself, but it does force the turbine to be made of exotic materials that are difficult to fabricate, especially to very tight tolerances that would be required. The net consequence of the first and second problems is that the a small turbine is difficult to gear down to a rotational speed that can be easily handled by any drive train. A typical piston engine rotates at well under 7,000 RPM, which is about 93,000 RPM less than that of the turbocharger rotational speed. High rotational speeds are advantages for all small turbomachines, including centrifugal superchargers, so 100,000 RPM is a good value for a turbocompressor.

In light of what has been described already about using a Roots device as a power extraction device, it should be obvious that a power extraction turbine is not really necessary. A very high pressure gain turbocharger can be used to drive a power extracting Roots device. Such a high pressure gain turbocompressor would have be driven by a high pressure ratio turbine. Such a layout is shown as FIG. 4. This layout is shown with two stages of turbocompressors, driving a single shaft. There are three stages of compressors, so that there would be a substantially super atmospheric pressure left even after a partial expansion in the Roots device 4. Of course, the Roots device 4 would function as a supercharger at low speeds. Note that this arrangement is conceptually very similar to the turbocompound engines of the 1950's that used a hydraulic coupling between the turbine and the crank. The hydraulic power coupling does not rely on gears that would erode in order to transfer power, but transfers power via hydrostatic pressure. In the scheme shown in FIG. 4, the air moving through the forced induction system functions as the power transfer fluid. Of course, a Roots device is not the ideal power extraction unit, but its polytropic losses are not excessive at modest pressure ratios, and permits some of the large amount of exhaust gas energy being wasted in current engines to be recovered for use. Most importantly, this layout can utilize a small volume flow of a small automobile engine effectively. The high compression ratio of this layout also makes this an effective aircraft engine layout, in which the supercharger would be fitted with a bypass valve, shown as 22A, and a disengaging clutch for high altitude operations, which is not shown.

For somewhat larger engines, a proper turbine can be fitted downstream of a turbocharger on a separate shaft. FIG. 1 shows such a layout. The high temperature, high pressure exhaust gas 7 is first channeled through the turbocharger turbine 8. This reduces the gas temperature substantially, while increasing the gas volume. Thus, the gas exiting the turbine 8 is suitable for use in a larger turbine that can be readily geared using common supercharger gearing. The exhaust gas from the high pressure turbine 8 is fed in to the low pressure power extraction turbine 9. The expected temperature of gas entering the turbine is on the order of advanced steam turbine temperatures, and the total pressure would be on the order of 2 to 4 ATM. The volume flow rate of this gas would not be less than that through a common crank driven centrifugal supercharger, which means that a centrifugal turbine with dimensions and operating parameters similar to a centrifugal supercharger can be used as a power extracting turbine. It is reasonable to expect that common stainless steel will be good enough a construction material in many cases, and that 30,000 RPM gearing will be suitable for such a turbine. Of course, since a Roots type device 4 is already present, it is easy enough to connect the power extraction turbine shaft 12 to the Roots device 4, which is itself connected to the crank. However, even though Roots device 4 and the turbine 9 may share the same drive shaft, this is not a low speed turbocharger. At low speed, the turbine is extracting little power, and the supercharger is consuming much power, supplied by the crank. At high speed, turbine is extracting much power, but the Roots device absorbing little power, since its compression duties have been relieved by the turbocharger. So throughout most of the operating range of the engine, the power requirements of the Roots device and the power supplied by the turbine would be severely mismatched, and the devices could not function if uncoupled from the crank.

The presence of a power extraction turbine 9 is extremely important for the overall efficiency of the engine at high power settings. This turbine permits the underexpanded gases of a low expansion ratio piston engine to be fully expanded with useful power extraction. The turbines would be sized to offer complete expansion of the exhaust gases at maximum volume flow rate of the engine, which would also be the point at which the expansion ratio of the piston engine is the lowest. As mentioned above, the compression variation be achieved by actually changing the travel range of the piston or by altering ignition or fuel injection timing. No matter how the the compression ratio change is effected, high efficiency can be obtained by ensuring that the piston engine combustion reach the maximum design pressure and that the turbines offer sufficient expansion, ideally to ambient pressure. When the engine is operating at low power settings, the turbines will be ineffective, and will function as sound suppression chambers. Thus, some of the power extraction duties will shift from the piston engine to the turbine as the volume flow rate through the engine increases.

For aircraft operations, the fact that turbine 9 of FIG. 1 is the volume flow limiting stage is a handicap. As the aircraft gains altitude, its forced induction system will be required to operate across a larger pressure ratio. In that case, the fact that turbine 9 is coupled to the crank becomes a severe handicap. This turbine is limited by the rotational speed of the piston engine. An air-bearing supported turbocharger could simply turn faster to generate more pressure gain. One simple solution would be to design the high temperature turbine 8 for a larger pressure ratio, and incorporate an exhaust bypass route. FIG. 3 shows such a turbine layout. In this figure, the turbine 8 would be designed for a high pressure ratio, but would discharge through turbine 9 at sea levels. Although this would require operating turbine 8 at lower pressure ratio than its design ratio, turbines are very forgiving about this mode of flow mismatch. The turbine 8 would extract less power, but still operate efficiently even if there was a downstream stage 9. At higher altitudes, bypass valve 20 could be opened to adjust the exit pressure for turbine 8. At a high enough altitude, the turbine 9 would be bypassed altogether and de-clutched, along with the Roots type devices. Of course, it is advantageous to mount the Roots type device 4 and the turbine 9 on the same shaft so that they could be disengaged together.

If the engine's volume flow is large enough to efficiently drive a 30,000 RPM turbine, it is not necessary to extract power in a low pressure turbine. FIG. 5 shows this layout. The high temperature exhaust 7 drives the high pressure power extraction turbine 9A directly. Of course, the turbine would then have to be made of a material that can withstand the higher temperatures. The partially expanded gas from 9A will drive the low pressure turbine 8A, which drives the turbocompressors. A wastegate 21 can be fitted to regulate the flow of the exhaust gas into the turbocharger. This is the ideal layout if the volume flow is large enough, because the total pressure ratio is not limited by the piston engine speed.

Turbines 8 or 9 can be fitted with variable vane stators that are well known in prior art. These variable vanes are not particularly effective at extracting power from exhaust stream at low-intermediate power settings. However, they are very effective at causing the pressure of the exhaust stream 7 to be high. Keeping the exhaust pressure high is very important if the piston engine is a two stroke engine.

The case of electric power generation deserves special mention. Marine propulsion applications and locomotive applications have used diesel electric hybrid drives for many decades now. Such a propulsion scheme is now spreading to automobiles. If at least a part of the power output of the engine is desired in an electrical form, it is very easy to fit a generator or an alternator to a fast rotating turbine. In such a case, a 100,000 RPM alternator can extract power directly from the turbocharger shaft. Such a fast rotating alternator can offer a high power output for a given weight. Such an installation would increase the rotational inertia of the turbocharger assembly even more. However, the displacement superchargers shown in the present invention permits practical use of such installations with little turbo-lag.

A turbine configuration like that presented in FIG. 5 can be used as well. Even if the basic engine is small and requires 100,000 RPM rotational speeds out of shaft 12, an alternator can still be fitted without any difficulty. The presence of the waste gate 20A permits the low pressure turbine 8A to be bypassed altogether. Then, the power extraction turbine 9A is operated against the ambient pressure. This is a perfect scenario for part throttle operations when the volume flow rate of the exhaust gas is insufficient for operating the turbocharger at an effective speed. Since turbine 9A is smaller than turbine 8A, it can reach its efficient operating speeds with much less exhaust gas volume flow if it is operated against the ambient pressure. Fitting variable vane stators would improve the power extracting effectiveness of turbine 9A even more.

### REVIEW OF THE DIFFERENT EMBODIMENTS

There is no preferred embodiment, as different applications would call for different embodiments. The following are guidelines that determine how different embodiments would be configured.

### First Embodiment

### Low Pressure Gain

FIG. 1 is the configuration for which a lower pressure gain at the forced induction system is desirable. One obvious case is that of a fixed compression ratio engine. Such an engine must use a high enough compression ratio for acceptable starting performance, so the peak pressures delivered by the forced induction system needs to be limited to the relatively high compression ratio of the piston engine. FIG. 1 shows one stage of Roots device 4, one stage of turbocompressor 2, one stage of compressor driving turbine 8, and one stage of power extraction turbine 9. The upstream location of the Roots device 4 ensures that there is virtually no turbo-lag. The Roots device will be operating as a low pressure compressor at maximum turbomachinery speed.

This layout is optimized for constant altitude operations, such as in automobiles or ships. Deploying this embodiment is extremely simple. One can reduce the compression ratio of any given piston engine, and “bolt on” the forced induction system of FIG. 1. Not only will the engine show the typical power increase that results from a higher manifold charge density, the engine will show a substantial increase in thermodynamic efficiency because of the presence of the turbine 9. This turbine turns a conventional piston engine into a complete expansion engine.

### Second Embodiment

### High Pressure Gain

FIG. 2 shows the implementation of this invention with two turbocompressor stages for higher pressure gain. The displacement supercharger 4 is placed downstream of the turbocompressor 2. At maximum turbomachinery speed, the Roots device will be operating as a low pressure compressor. Since there are a total of 3 compression stages, a very large pressure gain is possible, and a variable compression ratio engine should be used.

The presence of turbine 9 means that the engine's total expansion ratio is not limited by the compression ratio of the piston engine. Even if the piston engine capable of operating at a compression ratio of 6, and a total expansion ratio of 50 is desired, turbines 8 and 9 would accommodate the additional expansion. Since the engine efficiency is a function of the total expansion ratio, the total cycle efficiency is virtually independent of the piston engine compression ratio.

### Third Embodiment

### Large Performance Envelop

In some high performance and high output applications, it will be necessary to encompass a very wide range of ambient pressures. FIG. 3 is suitable for such uses. Aircraft and certain types of race cars operate in such conditions. Two stages of Roots superchargers 4A and 4B are used, and the turbine 8 will be designed for a large pressure ratio. Two bypass valves, 21 and 22, will also be commonly used.

For automotive applications with a variable compression ratio engine, 4A will be sized so that it will function as a low pressure compressor at maximum turbomachinery speed, as will 4B. Additional intercoolers can be placed as needed. The power extraction turbine 9 can be bypassed at high altitudes if the volume flow rate through it becomes restrictive. A wastegate 20 can be opened to adjust the pressure ratio for the turbine 8.

For aircraft applications, Roots devices 4A and 4B can be sized as mentioned above also. However, it may be desirable to size them so that they would function as flow restricting power extractors at maximum turbomachinery speed at sea level. This would permit the use of a much larger turbocompressor, suitable for high altitude operations. At high altitude, the wastegate 20 would adjust the exhaust pressures to deliver sufficient power to the turbocompressors. Roots device 4A would be bypassed through throttle 22, and de-clutched when completely bypassed.

Aircraft are extremely sensitive to weight, so it may be desirable to use a fixed low compression ratio engine. The presence of two Roots devices ensures that the forced induction system deliver sufficient pressure to the manifold for easy starting of low compression ratio engines. They permit the engine to power up to a level where their exhaust volume is able to effectively drive the turbines.

### Fourth Embodiment

### Very Small Engines

A very small power extraction turbine is difficult to make. If the engine is very small so that it cannot generate sufficient exhaust volume flow to operate a 30,000 RPM turbine effectively even after partial expansion in a high pressure turbine, the only practical method of extracting excess power from the exhaust gas is through the Roots device. FIG. 4 is suitable for such a piston engine. There are two exhaust turbine stages, 8 and 18. Thus, all of the power available in the exhaust is extracted through the Roots device 4 at high speeds, which would serve as a compressor at low speeds.

There are piston engine designs available that offer “complete expansion.” However, even if the exhaust pressure of a piston engine were less than the inlet manifold pressure, there is useful energy to be extracted as long as the total pressure is relatively high. (Of course, the gas turbine combustor exit pressure is always lower than its inlet pressure, and the turbomachinery still produces substantial power.) Such engines offer a larger expansion ratio than compression ratio, so there is may not be enough energy left in the exhaust to make a separate power extraction turbine worthwhile. FIG. 4 is suitable for such engines as well. Finally, it particularly suitable for aircraft engines, since there is no power extraction turbine to restrict the turbocharger expansion ratio.

This configuration lends itself well to extracting power directly out of the turbocharger shaft by means of an alternator or a generator.

### Fifth Embodiment

### Large Engines

Many large piston engines are used. FIG. 5 has its power extraction turbine 9A located upstream of its turbocharger driving turbine 8A. The location of 9A upstream of 8A requires that the exhaust volume flow be large enough to drive a 30000 RPM turbine effectively.

Marine, locomotive, and large transport aircraft engines would easily have the volume flow necessary for such a layout. The varying pressure ratio requirements of an aircraft application is easy to meet; the fact that 8A discharges to the atmosphere means that the turbine 8A sees a pressure ratio that varies with the altitude, so the turbocharger can be designed to simply spin faster at higher altitudes. Roots device 4 would be sized according to aforementioned guidelines. Such an engine would be far more efficient than current turboprop engines, yet weigh little more, especially if two stroke piston engine is used.

For smaller engines, an electric generator or an alternator can be used to extract power out of the fast rotating high pressure turbine.

1. A turbocompound system for supplying an internal combustion engine with compressed charge and extracting the available energy from the exhaust gas stream of said internal combustion engine, comprising:
(a) at least one displacement compressor means,
(b) a turbocharger means, comprising at least one dynamic compressor means, at least one expansion turbine means, and at least one shaft means of conveying all of the rotational power required by said dynamic compressor means from said expansion turbine means, and
(c) a piping or ducting means for conveying the compressed charge from said displacement compressor means to the inlet of the compressor of said turbocharger means,
whereby said displacement compressor means supplies said internal combustion engine with a predetermined volumetric flow rate of charge regardless of the rotational speed of said turbocharger means, and said displacement compressor is capable of functioning as a power extracting expansion device if said dynamic turbo-compressor operates at a rotational speed that causes the discharge pressure of said displacement compressor means to drop below that of its intake pressure.

2. A machine of claim 1, further including a low pressure power extracting expander means, and a ducting or piping means for conveying the exhaust gas from the outlet of said turbocharger means to the inlet of said low pressure power extracting expander means.

3. A machine of claim 1, further including at least one intercooler or aftercooler means, connected to the outlet of at least one of the compressor means.

4. A machine of claim 1, further including a high pressure power extracting expander means, and a piping or ducting means for conveying partially expanded exhaust gas from said high pressure power extracting expander means to said turbocharger means.

5. A machine of claim 4, further including variable vane stator means for said said high pressure power extracting turbine means.

6. A machine of claim 4, further including at least one waste gate means, connected to the outlet of said high pressure power extracting expander means, for diverting a desired amount of the exhaust gas discharged from said high pressure power extracting expander means away from the inlet of said turbocharger means.

7. A machine of claim 1, wherein the dynamic compressor of said turbocharger means is a multi-stage compressor.

8. A machine of claim 1, further including an alternator or a generator means, whose rotary shaft is attached to the power conveying shaft of said turbocharger means.

9. A turbocompound system for supplying an internal combustion engine with compressed charge and extracting the available energy from the exhaust gas stream of said internal combustion engine, comprising:
(a) a turbocharger means, comprising at least one dynamic compressor means, at least one expansion turbine means, and at least one shaft means of conveying all of the rotational power required by said dynamics compressor means from said expansion turbine means,
(b) a power extracting expander means, and
(c) a piping or ducting means for conveying gas discharged from the expansion turbine of said turbocharger means to said power extracting expander means,
whereby the expansion turbine of said turbocharger means supplies said power extracting expander means with a gas stream of reduced temperature and enlarged volumetric flow rate.

10. A machine of claim 9, further including at least one additional supercharger means, such that the supercharger compression stages and the turbocharger compression stages are connected in series.

11. A machine of claim 10, wherein at least one of the additional supercharger means is a displacement compressor.

12. A machine of claim 10, further including a means for de-clutching or otherwise disconnecting at least one of said additional supercharger means from its source of rotational power.

13. A machine of claim 10, further including a bypass duct that conveys the charge from the inlet of at least one of said additional supercharger means to its outlet, and a valve means for closing off said bypass duct.

14. A machine of claim 10, further including at least one intercooler or aftercooler means, connected to the outlet of at least one of the compression stages.

15. A machine of claim 9, further including variable vane stator means for said turbocharger means.

16. A machine of claim 9, further including at least one intercooler or aftercooler means, connected to the outlet of the compressor of said turbocharger means.

17. A machine of claim 9, further including variable stator means for said power extracting expander means.

18. A machine of claim 9, further including further including at least one waste gate means, connected to the outlet of the expansion turbine of said turbocharger means, for diverting a desired amount of the exhaust gas discharged from the expansion turbine of said turbocharger means away from the inlet of said power extracting expander means.

19. A method for extracting available energy of exhaust gas of an internal combustion engine, comprising:
(a) expanding said exhaust gas in a turbocharger means, thereby transferring the available enthalpy extracted from the expansion turbine of said turbocharger means to a compressed charge stream discharging from the compressor of said turbocharger means, and
(b) extracting a part of the enthalpy of said compressed charge stream from said turbocharger means by partially expanding said compressed charge stream in an expander device to a predetermined pressure level,
whereby the available enthalpy of said exhaust gas was transfered via said turbocharger means to said compressed charge stream to said expander device.

20. A method of claim 19, further including at least one additional compression step after the partial expansion step, said additional compression step being accomplished by means of at least one additional turbocharger compression stage.
